(19) United States
(12) Patent Application Publication
(10) Pub. No.: US 2016/0051908 A1
(43) Pub. Date: Feb. 25, 2016

(54) FILTER APPARATUS AND METHODS FOR PROVIDING BOILER FEED WATER

(71) Applicant: Clement F. Meyer, Glenwood Springs, CO (US)

(72) Inventor: Clement F. Meyer, Glenwood Springs, CO (US)

(73) Assignee: MEYER BOILER COMPANY, Glenwood Springs, CO (US)

(21) Appl. No.: 14/832,686

(22) Filed: Aug. 21, 2015

Related U.S. Application Data
(60) Provisional application No. 62/040,910, filed on Aug. 22, 2014.

(51) Int. Cl. B01D 24/46; C02F 1/00

(52) U.S. Cl. CPC B01D 24/4631; C02F 1/004

(57) ABSTRACT

A filter apparatus includes an intake conduit that receives intake water. A bypass conduit receives intake water from the intake conduit in a filtering mode. A first discharge conduit receives intake water from the bypass conduit and discharges intake water to a waste receptacle in the filtering mode. A filter device receives intake water from the intake conduit in the filtering mode. The filter device removes suspended solids from intake water in the filtering mode. A second discharge conduit receives filtered water from the filter device in the filtering mode. The second discharge conduit discharges filtered water to a water receptacle in the filtering mode. The filter device receives water to remove suspended solids from the filter device in the backwashing mode. The first discharge conduit receives water and suspended solids from the filter device and discharges water and suspended solids to the waste receptacle in the backwashing mode.

### CROSS-REFERENCE TO RELATED APPLICATION

The present application claims the benefit of and priority to, under 35 U.S.C. §119(e), U.S. Provisional Application Ser. No. 62/040,910, filed Aug. 22, 2014, entitled FILTER APPARATUS AND METHODS FOR PROVIDING BOILER FEED WATER, which is hereby incorporated by reference in its entirety for all purposes.

### TECHNICAL FIELD

The present invention relates to filter apparatus and methods. More specifically, the present invention relates to filter apparatus and methods for providing boiler feed water.

### BACKGROUND

Boilers are commonly used to provide heated or vaporized water in a variety of applications, such as radiant heating, power generation, and the like. The water provided to the intake of the boiler, or “feed water”, is typically treated to remove dissolved particles. Dissolved particles could otherwise lead to corrosion and scale formation within the boiler, which is typically difficult and expensive to remove. Treated feed water that removes suspended solids is unavailable in remote locations, such as oil drilling locations. In contrast, untreated water (for example, rain water, snowmelt water, river water, and the like) is typically available in remote locations. However, mobile feed water treatment systems that remove suspended solids are relatively large, complex, unsuitable for inclement weather conditions, and require frequent monitoring by an operator. As a result, the use of mobile feed water treatment systems that remove suspended solids to provide boiler feed water at remote locations is often prohibitively expensive.

### SUMMARY

A filter apparatus for providing boiler feed water according to an embodiment of the present invention is operable in a filtering mode and a backwashing mode. In the filtering mode, the filter apparatus removes suspended solids from intake water to provide filtered water. In the backwashing mode, the filter apparatus discharges the suspended solids from the filter apparatus to, for example, a mud tank. The filter apparatus includes an intake conduit that is adapted to receive intake water from a water source, such as, for example, a rig tank. A bypass conduit receives intake water from the intake conduit in the filtering mode. A first discharge conduit receives intake water from the bypass conduit in the filtering mode to, for example, inhibit water from freezing in the first discharge conduit and the intake conduit in inclement weather conditions. The first discharge conduit is adapted to discharge intake water to a waste receptacle, such as, for example, the mud tank, in the filtering mode. A filter device receives intake water from the intake conduit via, for example, the rig tank in the filtering mode. The filter device is adapted to remove suspended solids from intake water to provide filtered water in the filtering mode. A second discharge conduit receives filtered water from the filter device in the filtering mode. The second discharge conduit is adapted to discharge filtered water to a filtered water receptacle, such as, for example, a boiler feed water tank, in the filtering mode. The filter device receives water from, for example, the boiler feed water tank to remove suspended solids from the filter device in the backwashing mode. The first discharge conduit receives water and suspended solids from the filter device in the backwashing mode. The first discharge conduit is adapted to discharge water and suspended solids to the waste receptacle, for example, the mud tank, in the backwashing mode.

A filter apparatus for providing boiler feed water according to an embodiment of the present invention is operable in a filtering mode and a backwashing mode. In the filtering mode, the filter apparatus removes suspended solids, such as, for example, sand and silt, from intake water to provide filtered water. In the backwashing mode, the filter apparatus discharges the suspended solids from the filter apparatus. The filter apparatus includes a first intake conduit that is adapted to receive intake water from a water source, such as, for example, a rig tank. A filter device receives intake water from the first intake conduit in the filtering mode. The filter device is adapted to remove suspended solids from intake water to provide filtered water in the filtering mode. A discharge conduit receives filtered water from the filter device in the filtering mode. The discharge conduit is adapted to discharge filtered water to a filtered water receptacle, such as, for example, a boiler feed water tank, in the filtering mode. A second intake conduit is adapted to receive filtered water from the filtered water receptacle. The second intake conduit delivers filtered water to the filter device to remove suspended solids from the filter device in the backwashing mode. A bypass conduit receives filtered water from the second intake conduit and delivers filtered water to the discharge conduit in the filtering mode to, for example, inhibit water from freezing in the discharge conduit and the second intake conduit in inclement weather conditions.

A method for providing boiler feed water according to an embodiment of the present invention includes operating a filter apparatus in a filtering mode by: delivering intake water to a filter device of the filter apparatus; using the filter device to remove suspended solids from intake water and provide filtered water; delivering intake water to a waste receptacle, such as, for example, a mud tank, by bypassing the filter device; delivering filtered water from the filter device to a filtered water receptacle, such as, for example, a boiler feed water tank; circulating filtered water between the filter apparatus and the filtered water receptacle by: (A) delivering filtered water from the filtered water receptacle to the filter apparatus; and (B) delivering filtered water from the filter apparatus to the filtered water receptacle by bypassing the filter device.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a schematic of an exemplary filter apparatus according to an embodiment of the present invention; the direction of water flow in a filtering mode of the filter apparatus is represented with arrows positioned adjacent the conduits and on a control valve of the filter apparatus.

FIG. 2 illustrates another schematic of the filter apparatus of FIG. 1; the direction of water flow in a backwashing mode is represented with arrows positioned adjacent the conduits and on the control valve of the filter apparatus.

FIG. 3 illustrates a front view of another exemplary filter apparatus according to an embodiment of the present invention; panels are removed from a frame of the filter apparatus to illustrate a filter system of the filter apparatus.

FIG. 4 illustrates a rear perspective view of the filter apparatus of FIG. 3; panels are removed from the frame of the filter apparatus to illustrate the filter system of the filter apparatus.

It should be understood that the drawings are intended facilitate understanding of exemplary embodiments of the present invention are not necessarily to scale.

### DETAILED DESCRIPTION

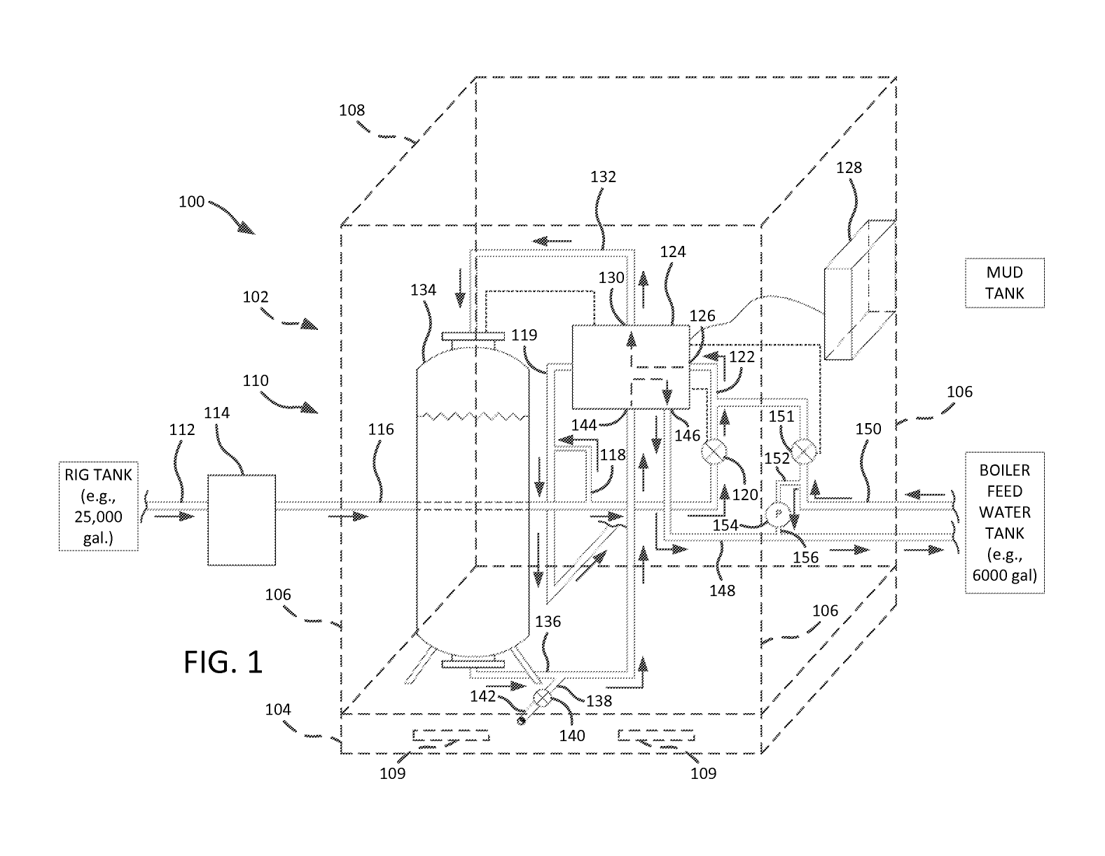

FIG. 1 illustrates a schematic of an exemplary filter apparatus 100 according to an embodiment of the present invention. The direction of water flow in a filtering or “normal” mode of the apparatus 100 is represented with arrows positioned adjacent the conduits and on a control valve of the filter apparatus 100.

The filter apparatus 100 includes a frame 102 that is adapted to support other components of the filter apparatus 100. In some embodiments, the frame 102 may have a general size of less than 7 feet wide by less than 6.5 feet long by less than 8 feet tall. In some embodiments, the frame 102 may have a general size of about 3.5 feet wide by about 5 feet long by about 7 feet tall (“about” meaning within three inches). Thus, in some embodiments, the filter apparatus 100 is relatively compact compared to other feed water treatment systems.

In some embodiments, the frame 102 and the other components of the filter apparatus 100 provide the filter apparatus 100 with a total weight of about 3000 lbs. (“about” meaning within 150 lbs.). Thus, in some embodiments, the filter apparatus 100 is relatively light-weight and portable compared to other feed water treatment systems.

In some embodiments, the frame 102 includes a base 104, one or more side walls 106, and/or a ceiling 108. The base 104, side walls 106, and/or the ceiling 108 may be formed by various appropriate components. For example, in some embodiments the base 104 may be formed by multiple four-inch steel I-beams. As another example, in some embodiments the side walls 106 and the ceiling 108 may be formed by steel sheet metal panels connected by two-inch steel square tubing. The base 104, side walls 106, and/or the ceiling 108 may be connected to each other in various appropriate manners, such as welding or the like. In some embodiments, the base 104 includes slots 109 for receiving the forks of a manually-driven or motor-driven fork truck (not shown).

The frame 102 supports a filter system 110 that filters intake water (for example, pond water, rain water, and/or snowmelt soft water that contains sand, silt, and/or suspended solids) to provide boiler feed water. The filter system 110 includes a first intake conduit 112 that receives intake water. In some embodiments, the first intake conduit 112 has an internal diameter of 2 inches. In some embodiments, the first intake conduit 112 is in fluid communication with and, in the filtering mode of the apparatus 100, receives intake water from an external water source or rig tank, for example, a rig tank having a capacity of about 25,000 gallons. The first intake conduit 112 is in fluid communication with and, in the filtering mode of the apparatus 100, delivers water to a coarse sand filter device 114.

The coarse filter device 114 may be, for example, a pot strainer. In some embodiments, the coarse filter device 114 is adapted to remove relatively-large objects, such as plant debris, rock pebbles, or the like, from the intake water. In some embodiments, the coarse filter device 114 has a mesh size of 1/16-inch. In some embodiments, the coarse filter device 114 is disposed outside of the frame 102 to facilitate service by a rig employee. In some embodiments, the coarse filter device 114 is disposed inside of the frame 102. The coarse filter device 114 is in fluid communication with and, in the filtering mode of the apparatus 100, delivers water to a first intermediate conduit 116.

In some embodiments, the first intermediate conduit 116 has an internal diameter of 2 inches. The first intermediate conduit 116 is in fluid communication with and, in the filtering mode of the apparatus 100, delivers a portion of the intake water to a first or filter bypass conduit 118. In some embodiments, the first bypass conduit 118 has an internal diameter of ¾-inch. The first bypass conduit 118 is in fluid communication with and, in the filtering mode of the apparatus 100, delivers the intake water to a first discharge conduit or a backwashed water discharge conduit 119. In some embodiments, the first discharge conduit 119 has an internal diameter of 2 inches. The first discharge conduit 119 is in fluid communication with and delivers water to an external waste receptacle or “mud tank”. In the backwashing mode, which is described in further detail below, the first discharge conduit 119 delivers water and suspended solids removed from the intake water to the waste receptacle. In the filtering mode, intake water flows through the bypass conduit 118 and the first discharge conduit 119 to the waste receptacle. This flow inhibits water from freezing in the first discharge conduit 119 and the first intake conduit 112 in inclement weather conditions.

Beyond the first bypass conduit 118, the first intermediate conduit 116 is in fluid communication with and, in the filtering mode of the apparatus 100, delivers the remainder of the intake water to an intake water control valve 120.

The intake water control valve 120 may include, for example, a 77-AR series valve and an AE-series actuator available from Apollo® Valves of Matthews, N.C. The intake water control valve 120 is open in the filtering mode of the apparatus 100. The intake water control valve 120 is electrically and automatically controlled as described in further detail below. The intake water control valve 120 is in fluid communication with and, in the filtering mode of the apparatus 100, delivers water to a second intermediate conduit 122.

In some embodiments, the second intermediate conduit 122 has an internal diameter of 2 inches. The second intermediate conduit 122 is in fluid communication with and, in the filtering mode of the apparatus 100, delivers water to a control valve 124.

In some embodiments, the control valve 124 is a five-way control valve, such as, for example, a Fleck 2850 control valve available from Pentair Water, and the second intermediate conduit 122 delivers water to a first port 126 of the control valve 124. The control valve 124 receives power from a power supply 128. In some embodiments, the power supply 128 provides 24 volt DC, one amp electrical power to the control valve 124. In some embodiments, the power supply 128 receives 208 volt, 30 amp, three phase electrical power from an external generator (not shown). In some embodiments, the control valve 124 is in operable communication with and controls the intake water control valve 120. A second port 130 of the control valve 124 is in fluid communication with and, in the filtering mode of the apparatus 100, delivers water to a third intermediate conduit 132.

In some embodiments, the third intermediate conduit 132 has an internal diameter of 2 inches. The third intermediate conduit 132 is in fluid communication with and, in the filtering mode of the apparatus 100, delivers water to a fine filter device 134. In some embodiments, the third intermediate conduit 132 delivers water to an inlet at or near the top of the fine filter device 134.

The fine filter device 134 is adapted to remove relatively-small suspended solids, such as sand and silt, from the intake water. In some embodiments, the fine filter device 134 is a sand filter. In some embodiments, the sand filter includes a SI2C1030F tank, two feet of SI2A7200 silica sand type as filtering media, and one foot of SI2A7005A of pea gravel as support media, each component being available from Stonehand Industries, Inc., of Lakewood, Colo. The fine filter device 134 discharges filtered water from an outlet, in some embodiments, at or near the bottom of the fine filter device 134. The fine filter device 134 is in fluid communication with and, in the filtering mode of the apparatus 100, delivers filtered water to a fourth intermediate conduit 136.

In some embodiments, the fourth intermediate conduit 136 has an internal diameter of 2 inches. The fourth intermediate conduit 136 is in fluid communication with a first drainage conduit 138. The first drainage conduit 138 is in fluid communication with a drainage control valve 140. The drainage control valve 140 is closed in the filtering mode of the filter apparatus 100. The drainage control valve 140 may be opened to drain water from the filter apparatus 100 through a second drainage conduit 142 (for example, to facilitate transporting the filter apparatus 100 to a different location; that is, conducting a rig move). In some embodiments, the drainage control valve 140 is a manually-actuated valve.

The fourth intermediate conduit 136 is also in fluid communication with and, in the filtering mode of the apparatus 100, delivers filtered water to a third port 144 of the control valve 124. A fourth port 146 of the control valve 124 is in fluid communication with and, in the filtering mode of the apparatus 100, delivers filtered water to a second discharge conduit or filtered water discharge conduit 148.

In some embodiments, the second discharge conduit 148 has an internal diameter of 2 inches. The second discharge conduit 148 is in fluid communication with and, in the filtering mode of the apparatus 100, delivers filtered water to an external filtered water receptacle. The external filtered water receptacle may be, for example, a boiler feed water tank (for example, a boiler feed water tank having a capacity of 6000 gallons) or an external apparatus for removing dissolved solids from the filtered water (that is, a “dissolved solids treatment apparatus”) that subsequently delivers water to the boiler tank. In some embodiments, the filter system 110 delivers filtered water to the filtered water receptacle at a rate in the range of 18 to 24 gallons per minute. In some embodiments, the filter system 110 delivers filtered water to the filtered water receptacle at a rate of about 21 gallons per minute (“about” meaning within 1 gallon per minute).

The filter system 110 also includes a second intake conduit 150. The second intake conduit 150 is in fluid communication with and receives filtered water from the filtered water receptacle. In some embodiments, the second intake conduit 150 has an internal diameter of 2 inches. The second intake conduit 150 is in fluid communication with a backwashing water control valve 151.

The backwashing water control valve 151 may include, for example, a 77-AR series valve and an AE-series actuator available from Apollo® Valves of Matthews, N.C. The backwashing water control valve 151 is electrically and automatically controlled as described in further detail below. The backwashing water control valve 151 is closed in the filtering mode of the apparatus 100. As described in further detail below, the backwashing water control valve 151 is open in the backwashing mode.

The second intake conduit 150 is also in fluid communication with and, in the filtering mode of the apparatus 100, delivers filtered water to a second or backwashing bypass conduit 152. In some embodiments, the second bypass conduit 152 has an internal diameter of ¾-inch. The second bypass conduit 152 is in fluid communication with and, in the filtering mode of the apparatus 100, delivers water to a pump 154.

The pump 154 draws filtered water from the boiler through the second intake conduit 150 and the second bypass conduit 152. The pump 154 may be, for example, a UP series pump available from Grundfos. The pump 154 is in fluid communication with and, in the filtering mode of the apparatus, delivers filtered water to a third bypass conduit 156.

In some embodiments, the third bypass conduit 156 has an internal diameter of ¾-inch. The third bypass conduit 156 is in fluid communication with and, in the filtering mode of the apparatus 100, delivers filtered water to the second discharge conduit 148. In the filtering mode, filtered water flows from the filtered water receptacle, through the second intake conduit 150, the second bypass conduit 152, the pump 154, the third bypass conduit 156, the second discharge conduit 148, and returns to the filtered water receptacle. This flow inhibits water from freezing in the second intake conduit 150 and the second discharge conduit 148 in inclement weather conditions.

In some embodiments, the apparatus 100 may be disposed within a boiler housing, and the second bypass conduit 152 and the third bypass conduit 156 may be omitted because water in the second intake conduit 150 and the second discharge conduit 148 is not susceptible to freezing.

In the filtering mode, suspended solids accumulate in the fine filter device 134. In order to maintain functionality of the fine filter device 134, the apparatus 100 may be backwashed to discharge the suspended solids from the fine filter device 134. In some embodiments, the apparatus 100 may automatically switch between the filtering mode and the backwashing mode. For example, the fine filter device 134 may include a pressure sensor or pressure switch (not shown; such as a series 1203 pressure differential switch available from Orange Research Inc. of Milford, Conn.) that is actuated when a pressure differential across the fine filter device 134 exceeds a threshold (such as, for example, 15 psi). The control valve 124 senses actuation of the pressure sensor and, in response, changes positions, closes the intake water control valve 120, and opens the backwashing water control valve 151 to change the direction of flow in some of the conduits. The apparatus 100 thereby changes from the filtering mode to the backwashing mode.

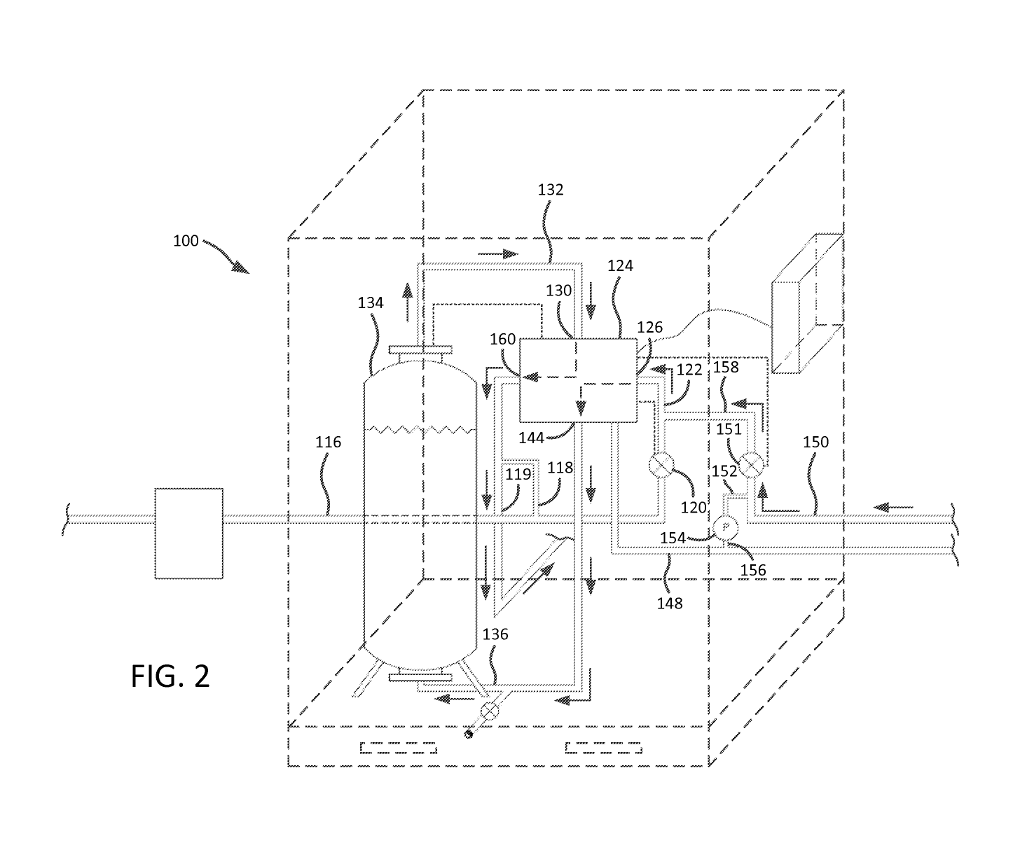

FIG. 2 illustrates a schematic of the filter apparatus 100 in the backwashing mode. The direction of water flow in the backwashing mode of the apparatus 100 is represented with arrows positioned adjacent the conduits and on the control valve 124 of the filter apparatus 100.

In the backwashing mode, the second intake conduit 150 receives filtered water from the filtered water receptacle. The second intake conduit 150 delivers filtered water to the backwashing water control valve 151. The backwashing water control valve 151 is in fluid communication with and, in the backwashing mode of the apparatus 100, delivers water to a fifth intermediate conduit 158.

In some embodiments, the fifth intermediate conduit 158 has an internal diameter of 2 inches.

The fifth intermediate conduit 158 is in fluid communication with and, in the backwashing mode of the apparatus 100, delivers filtered water to the second intermediate conduit 122. The second intermediate conduit 122 delivers filtered water to the first port 126 of the control valve 124. The control valve 124 delivers filtered water, via the third port 144, to the fourth intermediate conduit 136. The fourth intermediate conduit 136 delivers filtered water to the outlet of the fine filter device 134. The filtered water travels through the fine filter device 134 to remove suspended solids therefrom. The inlet of the fine filter device 134 delivers filtered water and suspended solids (referred to as “backwashed water”) to the third intermediate conduit 132. The third intermediate conduit 132 delivers backwashed water to the second port 130 of the control valve 124. The control valve 124 delivers backwashed water, via a fifth port 160, to the first discharge conduit 119. The first discharge conduit 119 delivers the backwashed water to the waste receptacle (for example, the mud tank).

In some embodiments, the filter apparatus 100 automatically exits the backwashing mode (that is, returns to the filtering mode) after a predetermined amount of time. In some embodiments, the filter apparatus 100 immediately returns to the backwashing mode if the pressure differential across the fine filter apparatus 134 again exceeds the threshold.

In some embodiments, intake water is delivered through the first intermediate conduit 116 and the first bypass conduit 118 in the backwashing mode. This action inhibits water from freezing in the first intermediate conduit 116 in the backwashing mode. In some embodiments, filtered water is delivered through the second intake conduit 150, the second bypass conduit 152, the pump 154, the third bypass conduit 156, and the second discharge conduit 148 in the backwashing mode. This action inhibits water from freezing in the second discharge conduit 148 in the backwashing mode.

In some embodiments, the filter apparatus 100 is suitable for inclement weather conditions because water continuously flows through conduits in fluid communication with external water sources and receptacles.

In some embodiments, the filter apparatus 100 requires relatively little maintenance or operator intervention because the filter apparatus 100 automatically switches between the filtering mode and the backwashing mode. In some embodiments, an operator need only service the coarse filter device 114, for example, on a daily basis, depending on the type of intake water that is delivered to the filter apparatus 100.

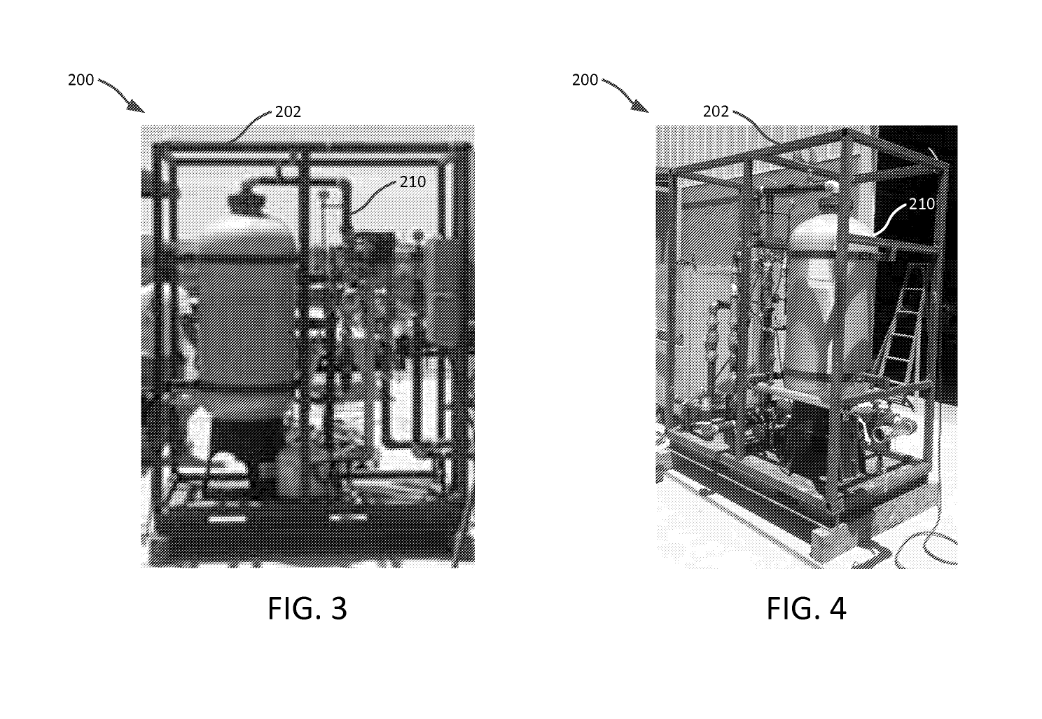

FIGS. 3 and 4 illustrate another exemplary filter apparatus 200 according to an embodiment of the present invention. The filter apparatus 200 is similar to the filter apparatus 100 described above. The filter apparatus 200 generally includes a frame 202 that supports a filter system 210. The filter system 210 filters intake water (for example, pond water, rain water, and/or snowmelt soft water that contains sand, silt, and/or suspended solids) to provide boiler feed water. Testing has demonstrated that the filter apparatus 200 is capable of removing a significant amount of suspended solids from river water. Specifically, the filter apparatus 200 has reduced the amount of suspended solids in river water by 200 ppm out of 2500 ppm, but the suspended solids that are removed are relatively large particles of sand and silt. The presence of the remaining suspended solids is not problematic in boiler feed water.

In some embodiments, a plurality of apparatus 100 may provide filtered water to a common boiler feed water tank. For example, two or “twin” apparatus 100 may be used provide filtered water to a common boiler feed water tank. In such an arrangement, one apparatus may operate in the filtering mode while the other apparatus may operate in the backwashing mode, and vice versa. In some cases, water for backwashing one apparatus may be received from the other apparatus instead of the boiler feed water tank.

Testing has also demonstrated that filter apparatus according to embodiments of the present invention, such as the filter apparatus 100 and the filter apparatus 200, significantly reduce the median and mean sizes of particles in river water. In particular, a sample of raw (that is, unfiltered) river water had a median particle size of 7.62163 μm and a mean particle size of 17.12107 μm (with an R parameter of 9.9633E-2 and a chi-squared statistic of 0.259863). Furthermore, A percent of particles in the sample of raw river water had a size of B microns or less as shown in Table 1.

TABLE 1

| A (percent) | B (μm) |
|---|---|
| 5.000 | 2.1793 |
| 10.00 | 3.0036 |
| 20.00 | 4.2456 |
| 30.00 | 5.3255 |
| 40.00 | 6.4065 |
| 60.00 | 9.1638 |
| 70.00 | 11.4107 |
| 80.00 | 16.7914 |
| 90.00 | 49.4074 |
| 95.00 | 78.5730 |

Additionally, particles in the sample of raw river water having a size of C microns or less constituted D percent of the particles in the sample as shown in Table 2.

TABLE 2

| C (μm) | D (percent) |
|---|---|
| 5.000 | 26.904 |
| 10.00 | 64.360 |
| 20.00 | 82.294 |
| 25.00 | 84.277 |
| 38.00 | 87.566 |
| 45.00 | 89.074 |
| 50.00 | 90.118 |
| 75.00 | 94.494 |
| 100.0 | 97.376 |
| 125.0 | 98.785 |

A sample of river water was filtered using a filter apparatus according to an embodiment of the present invention. The sample of filtered river water had a median particle size of 4.47002 μm and a mean particle size of 4.91754 μm (with an R parameter of 1.1653E-1 and a chi-squared statistic of 0.734433). Furthermore, A percent of particles in the sample of filtered river water had a size of B microns or less as shown in Table 3.

TABLE 3

| A (percent) | B (μm) |
|---|---|
| 5.000 | 1.6288 |
| 10.00 | 2.0783 |
| 20.00 | 2.7640 |
| 30.00 | 3.3550 |
| 40.00 | 3.9107 |
| 60.00 | 5.0750 |
| 70.00 | 5.7852 |
| 80.00 | 6.7079 |
| 90.00 | 8.2810 |
| 95.00 | 9.8056 |

Additionally, particles in the sample of filtered river water having a size of C microns or less constituted D percent of the particles in the sample as shown in Table 4.

TABLE 4

| C (μm) | D (percent) |
|---|---|
| 5.000 | 58.827 |
| 10.00 | 95.489 |
| 20.00 | 100.000 |
| 25.00 | 100.000 |
| 38.00 | 100.000 |
| 45.00 | 100.000 |
| 50.00 | 100.000 |
| 75.00 | 100.000 |
| 100.0 | 100.000 |
| 125.0 | 100.000 |

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A filter apparatus for providing boiler feed water, the filter apparatus being operable in a filtering mode and a backwashing mode, in the filtering mode the filter apparatus removing suspended solids from intake water to provide filtered water, and in the backwashing mode the filter apparatus discharging the suspended solids from the filter apparatus, the filter apparatus comprising:
an intake conduit adapted to receive intake water from a water source;
a bypass conduit receiving intake water from the intake conduit in the filtering mode;
a first discharge conduit receiving intake water from the bypass conduit in the filtering mode, the first discharge conduit being adapted to discharge intake water to a waste receptacle in the filtering mode;
a filter device receiving intake water from the intake conduit in the filtering mode, the filter device being adapted to remove suspended solids from intake water to provide filtered water in the filtering mode; and
a second discharge conduit receiving filtered water from the filter device in the filtering mode, the second discharge conduit being adapted to discharge filtered water to a filtered water receptacle in the filtering mode;
wherein the filter device receives water to remove suspended solids from the filter device in the backwashing mode, the first discharge conduit receives water and suspended solids from the filter device in the backwashing mode, and the first discharge conduit is adapted to discharge water and suspended solids to the waste receptacle in the backwashing mode.

2. The filter apparatus of claim 1, wherein the intake conduit is a first intake conduit, and further comprising a second intake conduit adapted to receive filtered water from the filtered water receptacle, wherein the filter device receives filtered water from the second intake conduit to remove suspended solids from the filter device in the backwashing mode, the first discharge conduit receives water and suspended solids from the filter device in the backwashing mode, and the first discharge conduit is adapted to discharge water and suspended solids to the waste receptacle in the backwashing mode.

3. The filter apparatus of claim 2, wherein the bypass conduit is a first bypass conduit, and further comprising a second bypass conduit receiving filtered water from the second intake conduit and delivering filtered water to the second discharge conduit in the filtering mode.

4. The filter apparatus of claim 1, further comprising a frame carrying the intake conduit, the bypass conduit, the first discharge conduit, the filter device, and the second discharge conduit.

5. The filter apparatus of claim 1, wherein the filter device comprises a sand filter.

6. A filter apparatus for providing boiler feed water, the filter apparatus being operable in a filtering mode and a backwashing mode, in the filtering mode the filter apparatus removing suspended solids from intake water to provide filtered water, and in the backwashing mode the filter apparatus discharging the suspended solids from the filter apparatus, the filter apparatus comprising:
a first intake conduit adapted to receive intake water from a water source;
a filter device receiving intake water from the first intake conduit in the filtering mode, the filter device being adapted to remove suspended solids from intake water to provide filtered water in the filtering mode;
a discharge conduit receiving filtered water from the filter device in the filtering mode, the discharge conduit being adapted to discharge filtered water to a filtered water receptacle in the filtering mode;
a second intake conduit adapted to receive filtered water from the filtered water receptacle, the second intake conduit delivering filtered water to the filter device to remove suspended solids from the filter device in the backwashing mode; and
a bypass conduit receiving filtered water from the second intake conduit and delivering filtered water to the discharge conduit in the filtering mode.

7. The filter apparatus of claim 6, wherein the discharge conduit is a filtered water discharge conduit, and further comprising a backwashed water discharge conduit receiving water and suspended solids from the filter device in the backwashing mode, the backwashed water discharge conduit being adapted to discharge water and suspended solids to a waste receptacle in the backwashing mode.

8. The filter apparatus of claim 6, further comprising a frame carrying the first intake conduit, the filter device, the discharge conduit, the second intake conduit, and the bypass conduit.

9. The filter apparatus of claim 6, wherein the filter device comprises a sand filter.

10. A method for providing boiler feed water by using a filter apparatus, the method comprising:
operating the filter apparatus in a filtering mode by:
delivering intake water to a filter device of the filter apparatus;
using the filter device to remove suspended solids from intake water and provide filtered water;
delivering intake water to a waste receptacle by bypassing the filter device;
delivering filtered water from the filter device to a filtered water receptacle;
circulating filtered water between the filter apparatus and the filtered water receptacle by:
(A) delivering filtered water from the filtered water receptacle to the filter apparatus; and
(B) delivering filtered water from the filter apparatus to the filtered water receptacle by bypassing the filter device.

11. The method of claim 10, further comprising operating the filter apparatus in a backwashing mode by:
delivering filtered water from the filtered water receptacle to the filter device;
using filtered water to remove suspended solids from the filter device; and
discharging filtered water and suspended solids to the waste receptacle.
